(19) United States
(12) Patent Application Publication
(10) Pub. No.: US 2014/0048611 A1
(43) Pub. Date: Feb. 20, 2014

(54) Spray Nozzle Light

(71) Applicant: AGCO Corporation, Duluth, GA (US)

(72) Inventor: Troy R. Palmquist, Trimont, MN (US)

(73) Assignee: AGCO Corporation, Duluth, GA (US)

(21) Appl. No.: 13/971,042

(22) Filed: Aug. 20, 2013

Related U.S. Application Data
(60) Provisional application No. 61/684,855, filed on Aug. 20, 2012.

(51) Int. Cl. A01C 23/00

(52) U.S. Cl. CPC A01C 23/007
USPC 239/1; 239/159

(57) ABSTRACT

An agricultural sprayer has a tank containing chemicals and a boom arm with a plurality of nozzle assemblies configured to disperse the chemicals in the tank. The nozzle assemblies include a conduit defining a fluid pathway and a spray nozzle in fluid communication with the fluid pathway. A turbine is operatively located within the fluid pathway and a light source is located proximate the spray nozzle and in electrical communication with the turbine. The light source is arranged to direct emitted light into a spray pattern produced by the spray nozzle.

### CROSS REFERENCE TO RELATED APPLICATION

This application claims the benefit of U.S. Provisional Application No. 61/684,855 entitled SPRAY NOZZLE LIGHT, filed Aug. 20, 2012, which is hereby incorporated by reference in its entirety.

### BACKGROUND OF THE INVENTION

1. Field of Invention

The present invention relates generally to a sprayer boom on a crop sprayer, and more particularly to a spray nozzle light on the sprayer boom.

2. Description of Related Art

The high crop yields of modern agribusiness require application of fertilizers, pesticides, and herbicides. Dispersing these chemicals onto high acreage fields requires specialized machines mounted on or towed by a vehicle. An example of such a machine is the self-propelled crop sprayer.

A common design for a self-propelled crop sprayer includes a dedicated chassis with a tank, boom arms, and nozzles connected to the boom arms. The tank contains fluid such as fertilizers, pesticides, and herbicides to be sprayed on agricultural crops in the field. Boom arms extend outward from the sides of the dedicated chassis. Boom plumbing contains supply lines and a plurality of nozzles spaced apart along the length of the boom arms at a standard spacing distance which corresponds to the spray pattern of the nozzles. In operation, as the crop sprayer crosses the field, fluid is pumped from the tank through the supply lines along the boom arms, and out through the nozzles. This allows the self-propelled sprayer to distribute the fluid along a relatively wide path. The length of conventional boom arms may vary from, for example, 6 meters (18 feet) up to 46 meters (150 feet), but smaller or longer booms are possible. The boom arms typically swing in for transport and out for operation.

In some situations it would be desirable to illuminate a spray pattern of the liquid. For example, a farmer may apply a liquid fertilizer at night and the farmer may desire to illuminate the applied liquid fertilizer's spray pattern to allow the farmer to view where the liquid is being deposited. In addition, illuminating the spray pattern may allow the farmer to notice if a spray nozzle is blocked or otherwise not spraying the liquid. It would therefore be advantageous to have spray nozzles lights on the boom arms of the crop sprayer.

### OVERVIEW OF THE INVENTION

In one embodiment, an agricultural sprayer has a tank containing chemicals and a boom arm with a plurality of nozzle assemblies configured to disperse the chemicals in the tank. The nozzle assemblies include a conduit defining a fluid pathway and a spray nozzle in fluid communication with the fluid pathway. A turbine is operatively located within the fluid pathway and a light source is located proximate the spray nozzle and in electrical communication with the turbine. The light source is arranged to direct emitted light into a spray pattern produced by the spray nozzle.

Consistent with embodiments of the invention, it may be possible to illuminate a spray pattern in each of a plurality of spray nozzles on a crop sprayer. In order to provide this, a turbine may be located proximate each spray nozzle within a conduit transporting the liquid. Each turbine may generate electrical energy to power a connected light source. Locating the turbine within the conduit transporting the liquid may allow the light source to be powered independent of the crop sprayer's electrical system. The light source may direct emit light into the spray pattern. The emitted light may refract within spray droplets comprising the spray pattern.

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 perspective view of a crop sprayer;

FIG. 2 is a schematic drawing showing a spray nozzle light on a boom arm of the crop sprayer of FIG. 1; and

FIG. 3 shows a flow chart for a method of illuminating a spray pattern using the spray nozzle light of FIG. 2.

The drawing figures do not limit the present invention to the specific embodiments disclosed and described herein. The drawings are not necessarily to scale, emphasis instead being placed upon clearly illustrating the principles of the preferred embodiment. Corresponding reference characters indicate corresponding parts throughout the views of the drawings.

### DETAILED DESCRIPTION OF THE PREFERRED EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

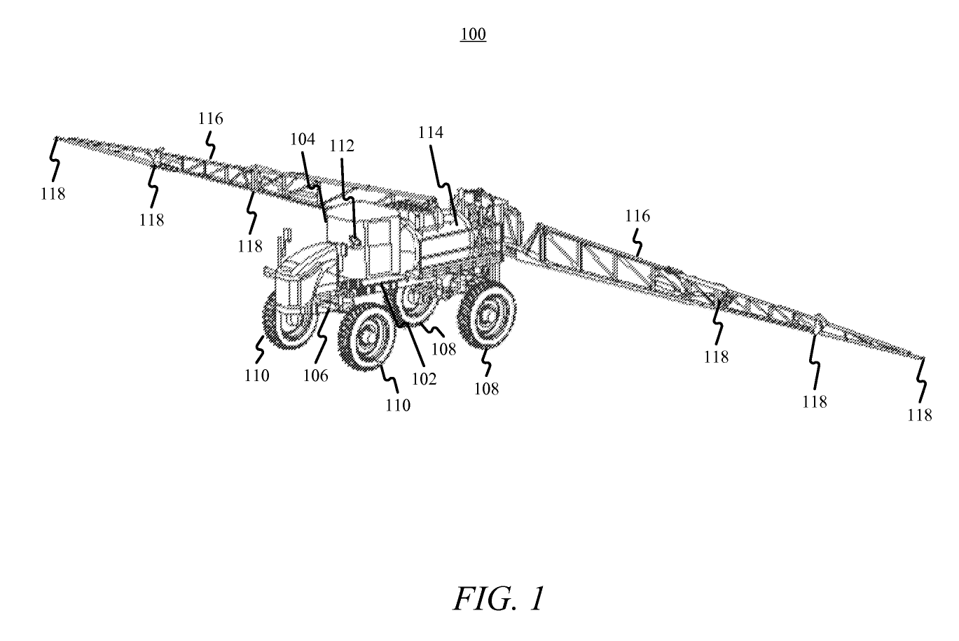

FIG. 1 shows a crop sprayer 100. Crop sprayer 100 includes a frame 102. Frame 102 may be of unitary construction or may include one or more pieces secured together. Frame 102 may comprise a support frame that may span the length of the crop sprayer 100 and may provide a structure for mounting other components on crop sprayer 100. Crop sprayer 100 may also include a cab 104 mounted on frame 102. Cab 104 may house an operator and a number of controls for crop sprayer 100.

In the illustrated embodiment, an engine 106 is mounted on a forward portion of frame 102 in front of cab 104, or may be mounted on a rearward portion of frame 102 behind cab 104. Engine 106 may be commercially available from a variety of sources and may comprise, for example, a diesel engine or may be a gasoline powered internal combustion engine. Engine 106 may be used to provide energy to propel crop sprayer 100 and may provide energy used to spray fluids from crop sprayer 100. Frame 102 is supported by a combination of rear and front wheels 108, 110. Rear wheels 108 may be driven by engine 106 so as to propel crop sprayer 100. In particular, engine 106 may generate mechanical energy that may be transferred to rear wheels 108 by a transmission (not shown), drive shaft (not shown), and rear differential (not shown). Front wheels 110 may be operable to steer crop sprayer 100. Propulsion and direction of the crop sprayer 100 may be controlled by one or more operator controls that include, but are not limited to, an accelerator (not shown), a brake (not shown), and a steering wheel 112. While a self-propelled crop sprayer 100 is shown while describing embodiments of the invention, one skilled in the art will understand that the invention may also be used is a towed crop sprayer without departing from the scope of the invention.

The crop sprayer 100 further includes a carrier tank 114 that may be used to store a liquid to be sprayed on a field. The liquid may comprise chemicals, such as but not limited to, water, herbicides, pesticides, or fertilizers. Carrier tank 114 may be mounted on frame 102, either in front of or behind cab 104. The crop sprayer 100 may include more than one tank to store different chemicals to be sprayed on the field.

The crop sprayer 100 further includes a boom arm 116 operable to distribute the liquid over a wide swath in the field. As will be described in greater detail below, a plurality of spray nozzle assemblies 118 may be spaced along boom arm 116 through which the liquid may be sprayed as crop sprayer 100 is driven forward in the field to distribute the chemicals onto crops in the field. The operator of the crop sprayer 100 may use a control handle, located in cab 104, to control boom arm 116 and the liquid dispersion through the spray nozzle assemblies 118. The operator may use the control handle to turn on the fluid flow to the plurality of spray nozzle assemblies 118 and to shut off the fluid flow to the plurality of spray nozzle assemblies 118.

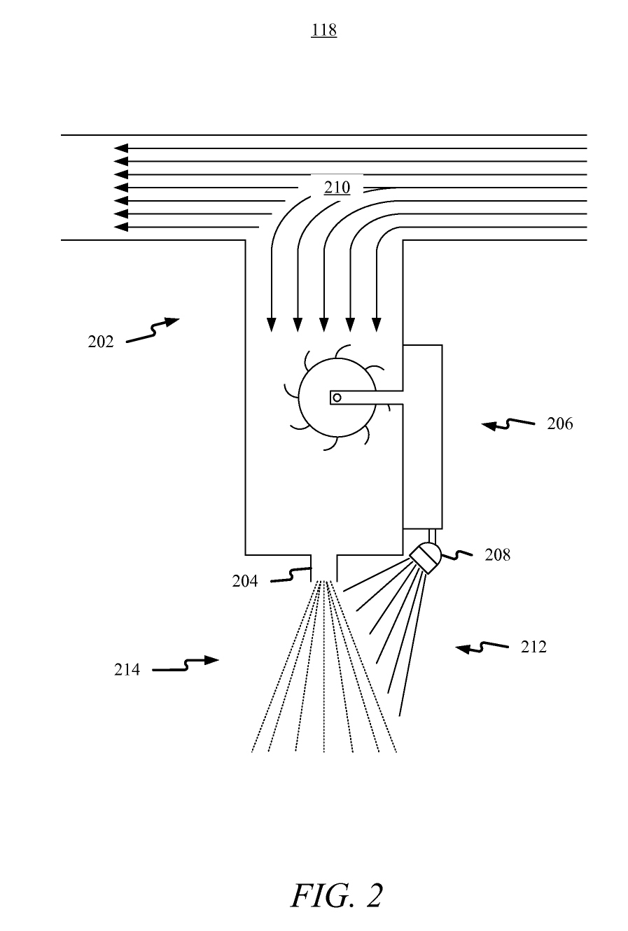

FIG. 2 shows spray nozzle assembly 118. As shown in FIG. 2, spray nozzle assembly 118 includes a conduit 202, a spray nozzle 204, a turbine 206, and a light source 208. A fluid 210 (i.e. liquid) flows through conduit 202 with the conduit 202 defining a fluid pathway for fluid 210 to reach the spray nozzle 204. The turbine 206 is operatively located within the conduit 202. The light source 208 is desirably located proximate the spray nozzle 204 and in electrical communication with the turbine 206. The light source 208 is arranged to direct an emitted light 212 into a spray pattern 214 produced by the spray nozzle 204.

During operation, an operator causes fluid 210 to flow through conduit 202 through operation of valves through any known means as would be understood in the art. As fluid 210 flows through the conduit 202, fluid 210 causes the turbine 206 to rotate. The turbine 206 comprises an electrical generator that converts energy of the flowing fluid 210 into electrical energy. As a result, the rotation of turbine 206 generates electricity to power the light source 208. Circuitry may be used to regulate the electrical current and convert the current from alternating current (AC) to direct current (DC) as is well known in the art and need not be discussed herein.

The conduit 202 may be an integral part of crop sprayer 100 or may be detachable from crop sprayer 100. For example, conduit 202 may be permanently attached to or located within boom arm 116. Conduit 202 may also be separable from boom arm 116.

The light source 208 may comprise any element that emits light. Examples include an LED light, an incandescent light, a florescent light, an optical fiber or fibers, and a neon light. When light source 208 comprises an optical fiber, the optical fiber may be placed in conduit 202, spray nozzle 204, or spray pattern 214. Light source 208 may include a single light or multiple lights. In one example embodiment, the boom arm 116 comprises light sources 208 that emit different color lights. For example, spray nozzle assemblies 118 located at different points along the boom arm 116 may be different colors to indicate a particular position on boom arm 116. For instance, spray nozzle assemblies 118 located toward the end of boom arm 116 may contain white lights and spray nozzle assemblies 118 located close to frame 102 may contain red lights. Furthermore, spray nozzle assemblies 118 may contain multiple lights of differing colors and the operator may be able to select the light color each spray nozzle assembly 118 or group of spray nozzle assemblies 118 emit. Moreover, different color lights may correspond to different fluids or chemicals exiting spray nozzle 204. For example, a green light may be utilized for a spray nozzle assembly plumbed to spray fertilizer, a red light for pesticides, a blue light for herbicides, and a white light for water. Of course, the colors described herein are for example purposes only and other colors may be used.

Desirably, the light source 208 is configured to emit light only when fluid 210 is flowing through the fluid pathway. In other words, light source 208 may not be connected to the electrical system of crop sprayer 100 and power may only be supplied to light source 208 when fluid 210 is flowing through spray nozzle 204. Having light source 208 only receive power from turbine 206 provides an indication of a blockage in conduit 202. For example, when conduit 202 contains a blockage and fluid is not able to flow or flows at a reduced flow rate, light source 208 may not emit light. The failure of light source 208 to emit light may indicate to the user that fluid is not flowing through spray nozzle 204 or is flowing at a reduced rate.

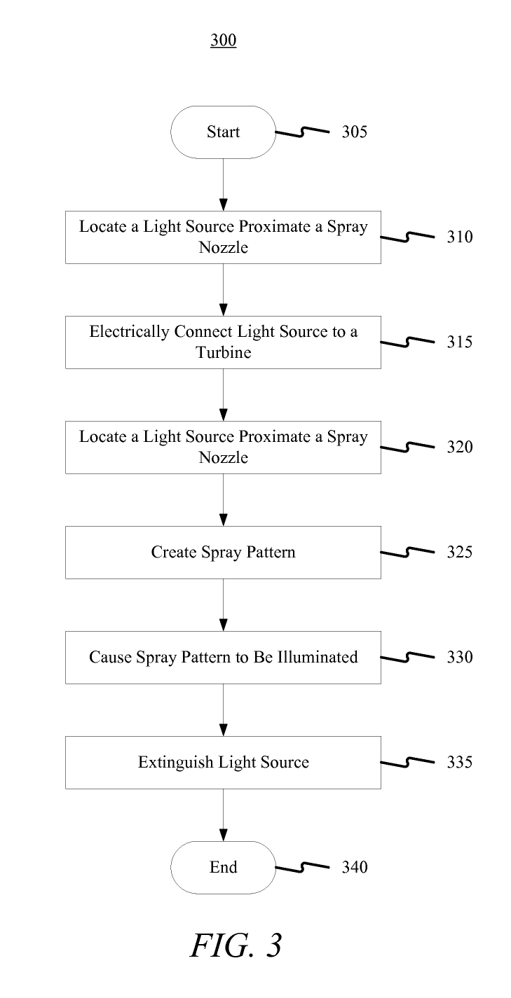

FIG. 3 is a flow chart setting forth the general stages involved in a method 300 for illuminating a spray pattern from spay nozzles 204 on the boom arm 216 of the crop sprayer 100. Ways to implement the stages of method 300 will be described in greater detail below. Method 300 may begin at starting block 305 and proceed to stage 310 where light source 208 may be located proximate spray nozzle 204. Light source 208 may be located within conduit 202. From stage 310 where light source 208 is located proximate spray nozzle, method 300 may proceed to stage 315 where light source 208 may be electrically connected to turbine 206.

From stage 315 where light source 208 is electrically connected to turbine 206, method 300 proceeds to stage 320 where spray pattern 214 is created. Spray pattern 214 is created by passing fluid 210 through conduit 202 and out spray nozzle 204. From stage 320 where spray pattern 214 is created, method 300 may proceed to stage 325 where light source 208 may cause spray pattern 214 to become illuminated. Light source 208 may cause spray pattern 214 to become illuminated by receiving electricity from turbine 206 and directing emitted light 212 into spray pattern 214. Emitted light 212 reflects and refracts within spray pattern 214.

From stage 325 where light source 208 causes spray pattern 214 to become illuminated, method 300 proceeds to stage 330 where the light source 208 may be extinguished. Light source 208 may be extinguished when fluid fails to flow through the conduit 202. The failure of fluid to flow through conduit 202 may be caused by a blockage or by an operator shutting down spray nozzle assembly 118. From stage 330 where light source 208 may be extinguished, method 300 may terminate at termination block 335.

Embodiments of the invention may provide a crop sprayer with a boom arm 116 having a plurality of spray nozzle assemblies 118. A plurality of spray nozzles may be in fluid communication with the fluid pathway and may be located at various positions along the boom. A plurality of turbines may be operatively located within the fluid pathway and may be located proximate at least one of the plurality of spray nozzles. A plurality of light sources may be located proximate at least one of the plurality of spray nozzles. The light sources may be in electrical communication with at least one of the plurality of turbines. Each of the plurality of light sources may be arranged to direct emitted light into a spray pattern produced by the plurality of spray nozzles.

Embodiments may provide a method for illuminating a spray pattern. The method may comprise locating a light source proximate a spray nozzle, the spray nozzle being connected to a conduit; electrically connecting the light source to a turbine located within the conduit; creating a spray pattern by passing a fluid though the conduit and out the spray nozzle; and causing the light source to illuminate the spray pattern by receiving electricity from the turbine at the light source when the fluid is flowing through the conduit.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. An agricultural sprayer having a tank containing chemicals and a boom arm with a plurality of nozzle assemblies configured to disperse the chemicals in the tank, wherein the nozzle assemblies comprise:
a conduit defining a fluid pathway;
a spray nozzle in fluid communication with the fluid pathway;
a turbine operatively located within the fluid pathway;
a light source located proximate the spray nozzle and in electrical communication with the turbine, the light source arranged to direct emitted light into a spray pattern produced by the spray nozzle.

2. The agricultural sprayer of claim 1, wherein the light source is configured to emit light only when a fluid is flowing through the fluid pathway.

3. The agricultural sprayer of claim 1, wherein the light source comprises at least one LED.

4. The agricultural sprayer of claim 1, wherein the light source comprises a plurality of different color lights.

5. The agricultural sprayer of claim 4, wherein each different color light corresponding to a different position on the boom arm.

6. The agricultural sprayer of claim 1, wherein the wherein the light source is configured to indicate a blockage in the fluid pathway.

7. The agricultural sprayer of claim 1, wherein the light source is power solely by the turbine.

8. An agricultural sprayer comprising:
a sprayer comprising a boom;
a conduit defining a fluid pathway;
a plurality of spray nozzles in fluid communication with the fluid pathway and located at various positions along the boom;
a plurality of turbines, each of the plurality of turbines operatively located within the fluid pathway and respectively located proximate the plurality of spray nozzles;
a plurality of light sources, each of the plurality of light sources respectively located proximate the plurality of spray nozzles and respectively in electrical communication with the plurality of turbines, each of the plurality of light sources arranged to direct emitted light into spray patterns produced by respective ones of the plurality of spray nozzles.

9. The agricultural sprayer of claim 8, wherein the plurality of light sources are configured to emit light only when a fluid is flowing through the fluid pathway.

10. The agricultural sprayer of claim 8, wherein the plurality of light sources comprise LEDs.

11. The agricultural sprayer of claim 8, wherein the plurality of light sources comprises a plurality of different color lights per light source.

12. The agricultural sprayer of claim 11, wherein each of the plurality of different color lights corresponds to a different chemical exiting the spray nozzle.

13. The agricultural sprayer of claim 8, wherein the plurality of light sources comprise a plurality of different color lights, each different color light corresponding to a different position on the boom.

14. The agricultural sprayer of claim 8, wherein the plurality of light sources are configured to indicate a blockage in the fluid pathway.

15. The agricultural sprayer of claim 8, wherein the plurality of light sources are respectively powered solely by the plurality of turbines.

16. A method of dispensing chemicals from a tank on an agricultural sprayer, the method comprising:
locating a light source proximate a spray nozzle, the spray nozzle being connected to a conduit;
electrically connecting the light source to a turbine located within the conduit;
creating a spray pattern by passing a fluid though the conduit and out the spray nozzle; and
causing the light source to illuminate the spray pattern by receiving electricity from the turbine at the light source when the fluid is flowing through the conduit to indicate that the chemicals from the tank are being dispensed by the spray nozzle.

17. The method of claim 16, further comprising extinguishing the light source when the fluid ceases flowing through the conduit.

18. The method of claim 17, wherein extinguishing the light source is in response to a blockage of the spray nozzle.

19. The method of claim 16, wherein the light source comprises a plurality of light sources, each light source being a different color.

20. The method of claim 16, wherein the fluid comprises a fertilizer.
